(19) United States
(12) Patent Application Publication
(10) Pub. No.: US 2013/0229700 A1
(43) Pub. Date: Sep. 5, 2013

(54) POLARIZATION MODE DISPERSION GENERATING DEVICE, METHOD FOR GENERATING POLARIZATION MODE DISPERSION AND POLARIZATION MODE DISPERSION COMPENSATING DEVICE

(71) Applicant: OKI ELECTRIC INDUSTRY CO., LTD., Tokyo (JP)

(72) Inventor: Yoshihiro KANDA, Tokyo (JP)

(73) Assignee: Oki Electric Industry Co., Ltd., Tokyo (JP)

(21) Appl. No.: 13/783,215

(22) Filed: Mar. 1, 2013

(30) Foreign Application Priority Data
Mar. 5, 2012 (JP) 2012-047757

(51) Int. Cl. G02F 1/01

(52) U.S. Cl. CPC G02F 1/0136; G02F 1/0115
USPC 359/239; 359/238

(57) ABSTRACT

It is possible to implement a PMD generating function which can set a PMD vector for each wavelength over wide wavelength bands and which has a simple control algorithm. A PCD and a DR can be controlled independently because the PMD can be set for each wavelength. Input signal light 101 is input to a first birefringent crystal 104 through a first fiber collimator 102, and is output after a first PMD is added. This output light is input to the first Stokes mapping device 105, and is output after a state of polarization is variably controlled. This output light is input to a second birefringent crystal 106, and is output after a second PMD is added. This output light is input to a Second Stokes mapping device 107, and a state of polarization is variably controlled.

### CROSS REFERENCE TO RELATED APPLICATION(S)

This application is based upon and claims benefit of priority from Japanese Patent Application No. 2012-047757, filed on Mar. 5, 2012, the entire contents of which are incorporated herein by reference.

### BACKGROUND

The present invention relates to a polarization mode dispersion generating device which generates polarization mode dispersion, a method for generating polarization mode dispersion, and a polarization mode dispersion compensating device which compensates polarization mode dispersion generated in an optical fiber transmission path.

Polarization Mode Dispersion (PMD) is a phenomenon of causing an arrival time difference between orthogonal polarization mode components of signal light at a receiving end, due to the birefringence distributed within an optical fiber transmission path. This arrival time difference is called a Differential Group Delay (DGD).

Generally, methods such as the multi-valuing of intensity information and phase information of signal light, the improvement of a symbol rate, the expansion of a wavelength bandwidth, and the multiplexing of a polarization space, are applicable to the acceleration of light transmission. Since a bit period becomes shorter when the symbol rate is improved, an influence of PMD will remarkably appear. Further, since a State of Polarization (SOP) is different with respect to the wavelength, signal light influenced by PMD will exert a negative effect on a polarization separation process executed at the receiving side, in optical communication by polarization multiplexing signal light using an orthogonal polarization space.

Therefore, an evaluation related to PMD tolerance is requested for an optical transmission system. In the evaluation of PMD tolerance of an optical transmission system, an evaluation is necessary not only for a first-order PMD vector, but also for a second-order PMD vector. A second-order PMD vector is divided into a Polarization-dependent Chromatic Dispersion (PCD), which is the frequency dependence of the DGD, and a Depolarization-Rate (DR), which represents the degree of rotation dependent on the frequency of a principal polarization axis.

Further, it may be necessary to collectively perform PMD compensation for the PCD and DR, in a transmission system with a high symbol rate and in a transmission system which performs wavelength division multiplexing communication. However, compensating the PMD over wide frequency bands is not easy, and there are problems to be solved, such as a control algorithm becoming complicated.

Until now, methods have been disclosed which equalize a second-order PMD by changing the phase for each frequency, by a spectrum shaper or the like, after collecting the extent of the state of polarization dependent on the frequency at a point of a Stokes space (refer to Mehmetcan Akbulut, et al., “Broadband All-Order Polarization Mode Dispersion Compensation Using Liquid-Crystal Modulator Arrays”, Journal of Lightwave Technology, Vol. 24, No. 1, January 2006, pp. 251-261, and JP 2010-273039A). Further, a method which enables the generation of PMD vectors, which includes second-order PMD, is also disclosed (refer to Jay N. Damask, et al., “Methods to Construct Programmable PMD Sources—Part II: Instrument Demonstrations”, Journal of Lightwave Technology, Vol. 22, No. 4, April 2004, pp. 1006-1013). Here, the state of polarization dependent on the frequency is expressed so as to correspond to a point within the Stokes space. The extent of the state of polarization is expressed as the distribution of points by the Stokes space.

### SUMMARY

In the method disclosed above in Mehmetcan Akbulut, et al., a phase recovery method, such as a Gerchberg-Saxton algorithm, is used in a control algorithm, and this algorithm requires high-degree and complex technology for use that is complex. Further, in the method disclosed above in JP 2010-273039A or in Jay N. Damask, et al., a method which compensates a PMD vector for each wavelength is adopted, and an adjustment of a phase shift amount between very large orthogonal polarization components, equivalent to about a ps (picosecond), is performed by an optical technique. It is not easy to design a configuration that can execute this adjustment accurately and at a high speed. Further, in the method disclosed in Jay N. Damask, et al., there is a problem in that it is difficult to independently control the PCD and DR.

However, a function may be requested, in which it is possible to independently control the PMD and DR by a simple control algorithm and over wide wavelength bands, in a device which generates a PMD and in a device which compensates a PMD generated in an optical fiber transmission path.

In order to solve the above problem, the inventors of the present application have newly conceived a Stokes mapping device which is able to continuously change a polarization rotation amount, by collecting PMD vectors different for each frequency in an S₁-S₂ plane, and additionally on an S₁ axis, of a Stokes space. Here, the PMD vectors different for each frequency are expressed as a three-dimensional distribution of points within the Stokes space.

Then, the inventors of the present application realized that if a PMD generating device is arbitrary configured using birefringent crystals and the Stokes mapping device, a PMD generating device may be realized which solves the above problem. That is, a configuration of a PMD generating device, which includes two birefringent crystals and two Stokes mapping devices, was discovered. Further, a configuration of a PMD compensating device, which uses this PMD generating device, was discovered.

Accordingly, the objective of the present invention is to provide a PMD generating device which is able to independently control a PMD, a PCD, and a DR by a simple control algorithm and over wide wavelength bands, and a PMD compensating device which can compensate an arbitrary PMD over wide wavelength bands.

According to the subject matter of the present invention, based on the above idea, the following PMD generating device and PMD compensating device are provided.

The PMD generating device according to the subject matter of the present invention includes a first birefringent crystal, a first Stokes mapping device, a second birefringent crystal and a second Stokes mapping device. The first birefringent crystal adds a first PMD when input signal light is input. The first Stokes mapping device variably controls a SOP for each wavelength when output light output from the first birefringent crystal is input. The second birefringent crystal adds a second PMD when output light output from the first Stokes mapping device is input. The second Stokes mapping device variably controls the SOP for each wavelength when output light output from the second birefringent crystal is input.

Further, the PMD compensating device according to the subject matter of the present invention includes an optical divider, the above described PMD generating device, a PMD analyzer, and an arithmetic unit. The optical divider divides input signal light into first input signal light and second input signal light. Then, the first input signal light is input to the PMD generating device, and the second input signal light is input to the PMD analyzer. The PMD analyzer measures PMD vectors of the second input signal light. The arithmetic unit requests inverse PMD vectors based on the PMD vectors obtained by the PMD analyzer, and calculates control parameters for controlling the PMD generating device.

According to the PMD generating device by the subject matter of the present invention, while details will be described later, it is possible to independently control a PMD, a PCD, and a DR by a simple control algorithm and over wide wavelength bands. Further, in all operations, which include the variable DGD operations necessary for PMD vector generation, the phase may be controlled in the range of 0 to 2π, and a very large phase adjustment, equivalent to about a ps (picosecond), by the optical techniques disclosed in the above described Mehmetcan Akbulut, et al. or Jay N. Damask, et al., may not be necessary.

According to the PMD compensating device by the subject matter of the present invention, it is possible to perform PMD compensation over wide wavelength bands by controlling a PMD generating device using control parameters requested by the arithmetic unit.

### BRIEF DESCRIPTION OF THE DRAWINGS

FIG. 1 is a block diagram which shows a schematic configuration of a PMD generating device;

FIG. 2 is a block diagram which shows a schematic configuration of a first polarization rotation device and a third polarization rotation device;

FIG. 3 is a block diagram which shows a schematic configuration of a second polarization rotation device and a fourth polarization rotation device;

FIG. 4 is a figure which provides a description for the operation of a first Stokes mapping device and a second Stokes mapping device;

FIG. 5 is a figure which shows the range of PMD vectors that can be generated by the PMD generating device;

FIG. 6 is a figure which shows the relation between a frequency and the magnitude of a DGD when only the magnitude of the DGD is changed, and without giving a frequency rotation of a principal polarization axis of a first and second birefringent crystal;

FIG. 7 is a figure which provides a description for rotating PMD vectors by setting the DGD as a constant (PCD=0);

FIG. 8 is a figure which shows arbitrary PMD vectors and DGD corresponding to a frequency;

FIG. 9 is a figure which shows PMD vectors and the frequency dependence of DGD, in the operation of step 1;

FIG. 10 is a figure which shows PMD vectors and the frequency dependence of DGD, in the operation of step 2;

FIG. 11 is a figure which shows PMD vectors and the frequency dependence of DGD, in the operation of step 3;

FIG. 12 is a figure which shows PMD vectors and the frequency dependence of DGD, in the operation of step 4;

FIG. 13 is a block diagram which shows a schematic configuration of a PMD compensating device; and

FIG. 14 is a figure which provides a description for inverse PMD vectors generated by the PMD generating device.

### DETAILED DESCRIPTION OF THE EMBODIMENT(S)

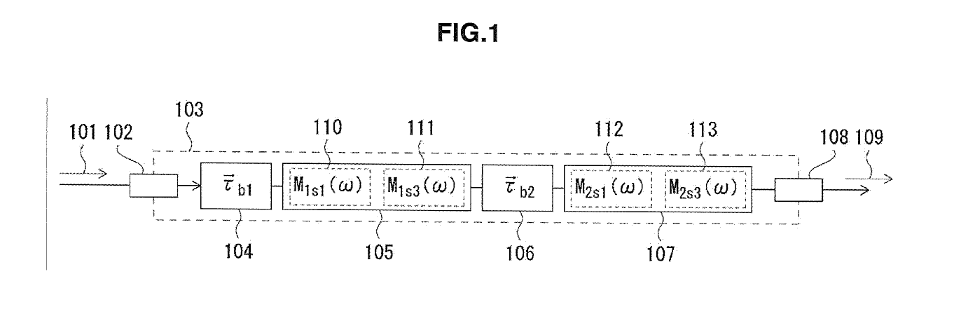

Hereinafter, the embodiments of the present invention will be described by referring to the figures. Note that FIGS. 1-3 and 13 illustrates configuration examples according to the present invention, which merely show schematically an arrangement relation or the like of each structural component to the degree that the present invention can be understood, and the present invention is not limited to these illustrated examples.

Further, while specific elements and operating conditions are adopted in the below description, these elements and operating conditions are merely one suitable example, and the present invention is not limited to any of these. Further, in order to express the vectors, while an arrow is attached to a character showing a vector amount or is shown by bold-face type, and the magnitude of the vectors is in general represented by normal characters, the below description is shown by normal characters except for cases where the vector amount is used within a numerical expression.

### <PMD Generating Device>

A configuration of a PMD generating device, the operation thereof, and the obtained effects, will be described by referring to FIGS. 1-7.

### (Configuration)

FIG. 1 is a block diagram which shows a schematic configuration of a PMD generating device. A PMD generating device 103 includes a first birefringent crystal 104, a first Stokes mapping device 105, a second birefringent crystal 106, and a Second Stokes mapping device 107.

The first birefringent crystal 104 adds a first PMD, when input signal light 101 is input through a first fiber collimator 102. The first Stokes mapping device 105 variably controls the SOP for each wavelength, when output light output from the first birefringent crystal 104 is input. The second birefringent crystal 106 adds a second PMD, when output light output from the first Stokes mapping device 105 is input. The second Stokes mapping device 107 variably controls the SOP for each wavelength, when output light output from the second birefringent crystal 106 is input. Then, output signal light 109 is output through a second fiber collimator 108.

The first Stokes mapping device 105 includes a first polarization rotation device 110 and a second polarization rotation device 111, and the second Stokes mapping device 107 includes a third polarization rotation device 112 and a fourth polarization rotation device 113. Each of the first polarization rotation device 110 and the third polarization rotation device 112 is enabled to continuously and variably adjust a rotation amount with an S₁ axis, which defines a Stokes space, as a center of rotation. Each of the second polarization rotation device 111 and the fourth polarization rotation device 113 is enabled to continuously and variably adjust a rotation amount with an S₃ axis, which defines a Stokes space, as a center of rotation.

A DGD that is the magnitude of a first PMD vector generated by the first birefringent crystal 104 is |τ_{b1}|, and a DGD that is the magnitude of a second PMD vector generated by the second birefringent crystal 106 is |τ_{b2}|. Further, M₁ₛ₁(ω), M₁ₛ₃(ω), M₂ₛ₁(ω), and M₂ₛ₃(ω) represent matrices which show a polarization rotation given by the first polarization rotation device 110, the second polarization rotation device 111, the third polarization rotation device 112, and the fourth polarization rotation device 113, respectively.

Accordingly, in order to aid understanding in FIG. 1, the first birefringent crystal 104 is expressed as [τ_{b1}], the first polarization rotation device 110 is expressed as [M₁ₛ₁(ω)], the second polarization rotation device 111 is expressed as [M₁ₛ₃(ω)], the second birefringent crystal 106 is expressed as [τ_{b2}], the third polarization rotation device 112 is expressed as [M₂ₛ₁(ω)], and the fourth polarization rotation device 113 is expressed as [M₂ₛ₃(ω)].

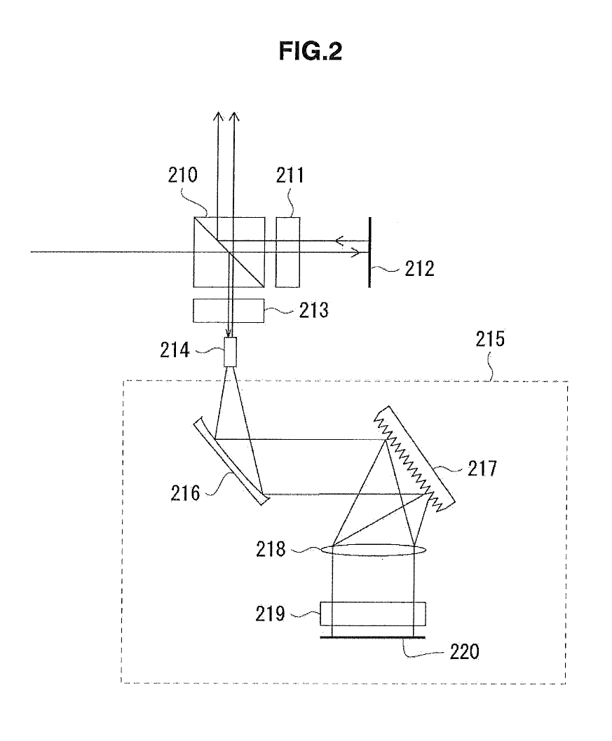

FIG. 2 is a block diagram which shows a schematic configuration of the first polarization rotation device 110 and the third polarization rotation device 112. Since the first polarization rotation device 110 and the third polarization rotation device 112 have a configuration that is identical, they are collectively shown in FIG. 2. However, the output light output from the first birefringent crystal 104 is input to the first polarization rotation device 110, and the output light output from the second birefringent crystal 106 is input to the third polarization rotation device 112.

The first polarization rotation device 110 and the third polarization rotation device 112 both include a polarization beam splitter 210, a first ¼ wavelength plate (45 degree ¼ wavelength plate) 211, a second ¼ wavelength plate (45 degree ¼ wavelength plate) 213, a first reflecting mirror 212, and a minute dispersion generating device 215.

In the first polarization rotation device 110, the output light output from the first birefringent crystal 104 is input to the polarization beam splitter 210, and is separated into two orthogonal polarization components, and in the second polarization rotation device 112, the output light output from the second birefringent crystal 106 is input to the polarization beam splitter 210, and is separated into two orthogonal polarization components.

One polarization component of the two polarization components output from the polarization beam splitter 210 passes through the first ¼ wavelength plate 211, is reflected by the first reflecting minor 212, passes again through the first ¼ wavelength plate 211, is reflected by the polarization beam splitter 210, and is input to the second polarization rotation device 111 (the fourth polarization rotation device 113 in the third polarization rotation device 112). The other polarization component passes through the second ¼ wavelength plate 213, is input to the minute dispersion generating device 215 through a fiber collimator 214, and is output after a phase shift amount for each wavelength of this other polarization component is adjusted. This output light passes again though the second ¼ wavelength plate 213, passes through the polarization beam splitter 210, and is input to the second polarization rotation device 111 (the fourth polarization rotation device 113 in the third polarization rotation device 112).

In this way, the first polarization rotation device 110 and the third polarization rotation device 112 are configured so that a function may be implemented which rotates a SOP with an S1 axis, which defines a Stokes space, as a center of rotation.

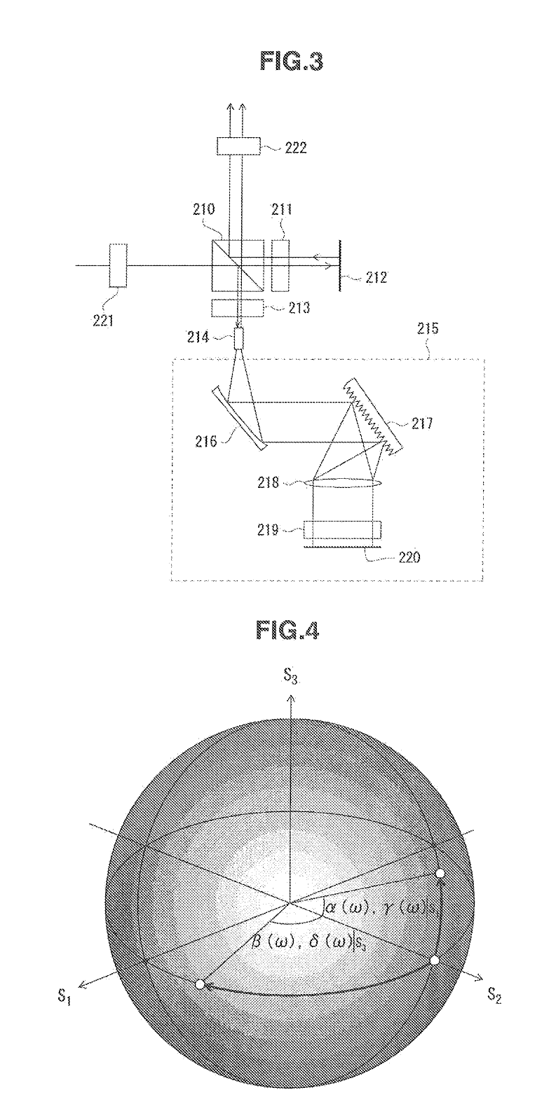

FIG. 3 is a block diagram which shows a schematic configuration of the second polarization rotation device 111 and the fourth polarization rotation device 113. Since the second polarization rotation device 111 and the fourth polarization rotation device 113 have a configuration that is identical, they are collectively shown in FIG. 3. However, the output light output from the first polarization rotation device 110 is input to the second polarization rotation device 111, and the output light output from the third polarization rotation device 112 is input to the fourth polarization rotation device 113.

The second polarization rotation device 111 and the fourth polarization rotation device 113 both include a third ¼ wavelength plate (45 degree ¼ wavelength plate) 221, a polarization beam splitter 210, a first ¼ wavelength plate 211, a second ¼ wavelength plate 213, a first reflecting mirror 212, a minute dispersion generating device 215, and a fourth ¼ wavelength plate (−45 degree ¼ wavelength plate) 222. The second polarization rotation device 111 and the fourth polarization rotation device 113, which are described here, are different from the first polarization rotation device 110 and the third polarization rotation device 112, which were described above, in that they further include the third ¼ wavelength plate (45 degree ¼ wavelength plate) 221 and the fourth ¼ wavelength plate (−45 degree ¼ wavelength plate) 222. The third ¼ wavelength plate 221 and the fourth ¼ wavelength plate 222 are also included so that a function may be implemented which rotates a SOP with an S₃ axis, which defines a Stokes space, as a center of rotation.

In the second polarization rotation device 111, the output light output from the first polarization rotation device 110 passes through the third ¼ wavelength plate 221, is input to the polarization beam splitter 210, and is separated into two orthogonal polarization components. In the fourth polarization rotation device 113, the output light output from the third polarization rotation device 112 passes through the third ¼ wavelength plate 221, is input to the polarization beam splitter 210, and is separated into two orthogonal polarization components.

One polarization component of the two polarization components output from the polarization beam splitter 210 passes through the first ¼ wavelength plate 211, is reflected by the first reflecting minor 212, passes again through the first ¼ wavelength plate 211, is reflected by the polarization beam splitter 210, passes through the fourth ¼ wavelength plate 222, and is input to the second birefringent crystal 106 (passes through the fourth ¼ wavelength plate 222 and is output to the outside in the fourth polarization rotation device 113).

The other polarization component passes through the second ¼ wavelength plate 213, is input to the minute dispersion generating device 215, is output after a phase shift amount for each wavelength of this other polarization component is adjusted, and this output light passes again though the second ¼ wavelength plate 213, passes through the polarization beam splitter 210, passes through the fourth ¼ wavelength plate 222, and is input to the second birefringent crystal 106 (passes through the fourth ¼ wavelength plate 222 and is output to the outside in the fourth polarization rotation device 113).

The minute dispersion generating device 215, as shown in FIGS. 2 and 3, includes a collimator minor 216, a diffraction grating 217, a lens 218, a phase shifter array 219, and a second reflecting minor 220.

The polarization component which is the other polarization component separated from the two orthogonal polarization components by the polarization beam splitter 210, and which has passed through the second ¼ wavelength plate 213, successively passes through the collimator mirror 216, the diffraction grating 217, the lens 218, and the phase shifter array 219, is reflected by the second reflecting mirror 220, passes again through the phase shifter array 219, the lens 218 and the diffraction grating 217 in this order, is reflected by the collimator mirror 216, and returns to the second ¼ wavelength plate 213.

The minute dispersion generating device 215 is a device that is able to adjust a phase shift amount independently for each wavelength, and can arbitrary use, for example, a variable band spectrum shaper or the like of Optoquest Co., Ltd. (refer to JP 2008-310190A for technical and detailed information of a variable band spectrum shaper). The minute dispersion generating device 215, as shown in FIGS. 2 and 3, performs spectrum dispersion by the diffraction grating 217, and is considered to have a configuration that can change a phase shift amount variably for each wavelength by the phase shifter array 219, after spectrum dispersion has been performed. Controlling a SOP for each wavelength is enabled and the first to fourth polarization rotation devices (110-113) are configured, by arranging the minute dispersion generating device 215 in an optical path other than that of a Michelson interferometer structure.

### (Operations)

The operations of the PMD generating device according to the embodiments of the present invention will be described by referring to FIG. 1. As described above, input signal light 101 is input to the PMD generating device 103 through the first fiber collimator 102, propagates through the first birefringent crystal 104, the first Stokes mapping device 105, the second birefringent crystal 106, and the second Stokes mapping device 107 in this order, and is output as output signal light 109 through the second fiber collimator 108.

When the laws of PMD connection are used, a PMD vector Ω(ω) generated by the PMD generating device 103 is given by the following Equation (1):

$$\begin{matrix} \begin{matrix}\text{?} ( ω ) = {M}_{2} ( ω ) ( \text{?} + {R}_{b 2} ( ω ) {M}_{1} ( ω ) \text{?} ) \\ = \text{?} ( ω ) \text{?} ( ω ) ( \text{?} + {R}_{b 2} ( ω ) \text{?} ( ω ) \text{?} ( ω ) \text{?} ( ω ) \text{?} )\end{matrix} & ( 1 ) \\ \text{?} \text{indicates text missing or illegible when filed} & \end{matrix}$$

Here, M₁(ω) is a 3×3 matrix which represents the polarization rotation given by the first Stokes mapping device 105, M₂(ω) is a 3×3 matrix which represents the polarization rotation given by the second Stokes mapping device 107, R_{b2} is a 3×3 matrix which represents the polarization rotation given by the second birefringent crystal 106, τ_{b1} is a 3×1 matrix which represents a first PMD vector added by the first birefringent crystal 104, and τ_{b2} is a 3×1 matrix which represents a second PMD vector added by the second birefringent crystal 106.

The first Stokes mapping device 105 is configured to include the first polarization rotation device 110 and the second polarization rotation device 111, and the second Stokes mapping device 107 is configured to include the third polarization rotation device 112 and the fourth polarization rotation device 113. A 3×3 matrix which represents the polarization rotation given by the first polarization rotation device 110 is represented by M₁ₛ₁(ω), a 3×3 matrix which represents the polarization rotation given by the second polarization rotation device 111 is represented by M₁ₛ₃(ω), a 3×3 matrix which represents the polarization rotation given by the third polarization rotation device 112 is represented by M₂ₛ₁(ω), and a 3×3 matrix which represents the polarization rotation given by the fourth polarization rotation device 113 is represented by M₂ₛ₃(ω).

The PMD generating device according to the embodiments of the present invention is considered to include a first group having the first birefringent crystal 104 and the first Stokes mapping device 105, and a second group having the second birefringent crystal 106 and the Second Stokes mapping device 107, and the first and second groups are of equal configurations.

M₁ₛ₁(ω), which gives the polarization rotation implemented by the first polarization rotation device 110, is a matrix which gives an SOP of light input to the first polarization rotation device 110, and a rotation with an S₁ axis, which defines a Stokes space, as a center of rotation. This rotation amount is given as a function of a phase difference γ(ω) between orthogonal polarization components generated by the first polarization rotation device 110.

M₁ₛ₃(ω), which gives the polarization rotation implemented by the second polarization rotation device 111, is a matrix which gives an SOP of light input to the second polarization rotation device 111, and a rotation with an S₃ axis, which defines a Stokes space, as a center of rotation. This rotation amount is given as a function of a phase difference δ(ω) between orthogonal polarization components generated by the second polarization rotation device 111.

M₂ₛ₁(ω), which gives the polarization rotation implemented by the third polarization rotation device 112, is a matrix which gives an SOP of light input to the third polarization rotation device 112, and a rotation with an S₁ axis, which defines a Stokes space, as a center of rotation. This rotation amount is given as a function of a phase difference α(ω) between orthogonal polarization components generated by the third polarization rotation device 112.

M₂ₛ₃(ω), which gives the polarization rotation implemented by the fourth polarization rotation device 113, is a matrix which gives an SOP of light input to the fourth polarization rotation device 113, and a rotation with an S₃ axis, which defines a Stokes space, as a center of rotation. This rotation amount is given as a function of a phase difference β(ω) between orthogonal polarization components generated by the fourth polarization rotation device 113.

The operation of the first Stokes mapping device 105 and the second Stokes mapping device 107 will be described by referring to FIG. 4. An S₁ axis, an S₂ axis and an S₃ axis, which define a Stokes space and are orthogonal, are shown in FIG. 4, and a state of movement (movement of the tip of a PMD vector) in the Stokes space of a point, which shows the SOP implemented by the first Stokes mapping device 105 and the second Stokes mapping device 107, is shown in FIG. 4. The circles of FIG. 4 show unit spheres, and the surfaces of these unit spheres show unit Stokes spaces. Further, the position corresponding to the SOP in the Stokes space is shown by white circles.

In FIG. 4, the relation in which an SOP is mapped at a Stokes space rotating with an S₁ axis as a center of rotation is shown with α(ω) and γ(ω)|S₁, by adjusting the phase difference γ(ω) between orthogonal polarization components generated by the first polarization rotation device 110, and the phase difference α(ω) between orthogonal polarization components generated by the third polarization rotation device 112. Further, the relation in which an SOP is mapped at a Stokes space rotating with an S₃ axis as a center of rotation is shown with β(ω) and δ(ω)|S₃, by adjusting the phase difference δ(ω) between orthogonal polarization components generated by the second polarization rotation device 111, and the phase difference β(ω) between orthogonal polarization components generated by the fourth polarization rotation device 113.

The polarization rotation generated by the second birefringent crystal 106 and given by R_{b2} is a rotation around an inherent axis of the second birefringent crystal 106, and this rotation ratio is given by φ(ω)=ω|τ_{b2}|. Here, while rotation with an S₁ axis as a center of rotation and rotation with an S₃ axis as a center of rotation are adopted as Stokes maps, the Stokes maps are not limited to these. That is, rotation with an S₁ axis as a center of rotation and rotation with an S₂ axis as a center of rotation may be adopted as Stokes maps.

Here, matrices M₁ₛ₁(ω), M₁ₛ₃(ω), M₁(ω), M₂ₛ₁(ω), M₂ₛ₃(ω), M₂(ω) and R_{b2}(ω) are specifically written as follows:

$$\text{?} ( ω ) = ( \begin{matrix}1 & 0 & 0 \\ 0 & cos γ ( ω ) & - sin γ ( ω ) \\ 0 & sin γ ( ω ) & cos γ ( ω )\end{matrix} )$$

$$\text{?} ( ω ) = ( \begin{matrix}cos δ ( ω ) & - sin δ ( ω ) & 0 \\ sin δ ( ω ) & cos δ ( ω ) & 0 \\ 0 & 0 & 1\end{matrix} )$$

$${M}_{1} ( ω ) = \text{?} ( ω ) \text{?} ( ω )$$

$$\text{?} ( ω ) = ( \begin{matrix}1 & 0 & 0 \\ 0 & cos α ( ω ) & - sin α ( ω ) \\ 0 & sin α ( ω ) & cos α ( ω )\end{matrix} )$$

$$\text{?} ( ω ) = ( \begin{matrix}cos β ( ω ) & - sin β ( ω ) & 0 \\ sin β ( ω ) & cos β ( ω ) & 0 \\ 0 & 0 & 1\end{matrix} )$$

$$\text{?} ( ω ) = \text{?} ( ω ) \text{?} ( ω )$$

$${R}_{b 2} ( ω ) = ( \begin{matrix}1 & 0 & 0 \\ 0 & cos φ ( ω ) & - sin φ ( ω ) \\ 0 & sin φ ( ω ) & cos φ ( ω )\end{matrix} )$$

$$\text{?} \text{indicates text missing or illegible when filed}$$

The first PMD vector generated by the first birefringent crystal 104 is assumed to be τ_{b1}, the second PMD vector generated by the second birefringent crystal 106 is assumed to be τ_{b2}, identical birefringent crystals are assumed to be used as the first birefringent crystal 104 and the second birefringent crystal, and it is assumed that τ_{b}=τ_{b1}=τ_{b2}=τ(|τ_{b}|,0,0)^{T}.

Here, if the phase difference between the orthogonal polarization components generated by the first polarization rotation device 110 is set to γ(ω)=−φ(ω), so that the birefringent phase φ(ω) of the second birefringent crystal 106 is cancelled, R_{b2}(ω)M₁ₛ₁(ω) in Equation (1) will become a non-unit matrix of the frequency dependence in the way shown in the following equation (here, E has the meaning of a unit matrix).

$${R}_{b 2} ( ω ) \text{?} ( ω ) = ( \begin{matrix}1 & 0 & 0 \\ 0 & cos \{ φ ( ω ) + γ ( ω ) \} & - sin \{ φ ( ω ) + γ ( ω ) \} \\ 0 & sin \{ φ ( ω ) + γ ( ω ) \} & cos \{ φ ( ω ) + γ ( ω ) \}\end{matrix} ) = E$$

$$\text{?} \text{indicates text missing or illegible when filed}$$

Then, the PMD vector Ω(ω) generated by the PMD generating device 103, in the case where it is controlled by γ(ω)=−φ(ω), is given by the following Equation (2):

$$\begin{matrix} \begin{matrix}\text{?} ( ω ) = {M}_{2} ( ω ) ( \text{?} + E \text{?} ( ω ) \text{?} ) \\ = \vert \text{?} \vert {M}_{2} ( ω ) ( \begin{matrix}1 + cos δ ( ω ) \\ sin δ ( ω ) \\ sin δ ( ω )\end{matrix} )\end{matrix} & ( 2 ) \\ \text{?} \text{indicates text missing or illegible when filed} & \end{matrix}$$

Then, the magnitude |Ω(ω)| of the PMD vector Ω(ω) is given by the following Equation (3):

|\vec{Ω}(ω)|=|\vec{τ}_{b}|√{right arrow over (2(1+cos δ(ω)))} (3)

Conversely, to set a prearranged PMD vector (intended PMD vector) generated by the PMD generating device 103 to Ω(ω), δ(ω) for each frequency may be set for a DGD, which is an absolute value of the set Ω(ω), in the way given by Equation (4):

$$δ ( ω ) = {cos}^{- 1} \{ \frac{1}{2} {( \frac{\vert \text{?} ( ω ) \vert}{\vert \text{?} \vert} )}^{2} - 1 \} \\ \text{?} \text{indicates text missing or illegible when filed} \qquad ( 4 )$$

By such a setting, a DGD spectrum, which gives the length of the intended PMD vectors for each frequency, can be obtained. Here, if the phase difference α(ω) between the orthogonal polarization elements generated by the third polarization rotation device 112, and the phase difference β(ω) between the orthogonal polarization elements generated by the fourth polarization rotation device 113, are controlled so the obtained PMD spectrum, by the second Stokes mapping device 107, has intended PMD vectors, a PMD vector different for each frequency can be arbitrary set by including a spectral range within the sphere in a Stokes space with a radius of 2|τ_{b}|. That is, as shown in FIG. 5, arbitrary and intended PMD vectors can be generated by including a spectral range within the sphere of a Stokes space with a radius of 2|τ_{b}|, which is colored with a shaded area.

The magnitude of the DGD for each frequency can be varied by the second polarization rotation device 111, by controlling the phase difference δ(ω) corresponding to the DGD. In addition, since it is possible for the PMD vectors corresponding to each frequency to be arbitrary mapped in a Stokes space with a radius of 2|τ_{b1}|, by controlling the phase difference α(ω) generated by the third polarization rotation device 112 and the phase difference β(ω) generated by the fourth polarization rotation device 113, it is possible to independently control a first-order PMD vector, a PCD and a DR.

This Free Spectral Range (FSR) is determined within a wavelength band of input signal light, depending on DGD generated by the first birefringent crystal 104 and the second birefringent crystal 106, and the applied band, which is able to generate an arbitrary PMD vector, is limited. If the magnitude of DGD generated by the first birefringent crystal 104 and the second birefringent crystal 106 are assumed to be |τ_{b}|, the FSR will be given by 1/(2|τ_{b}|). In the case where DGD generated by both the first birefringent crystal 104 and the second birefringent crystal 106 are 10 ps, for example, the FSR will become 100 GHz, and it becomes possible to generate arbitrary PMD vectors over a frequency band of 100 GHz.

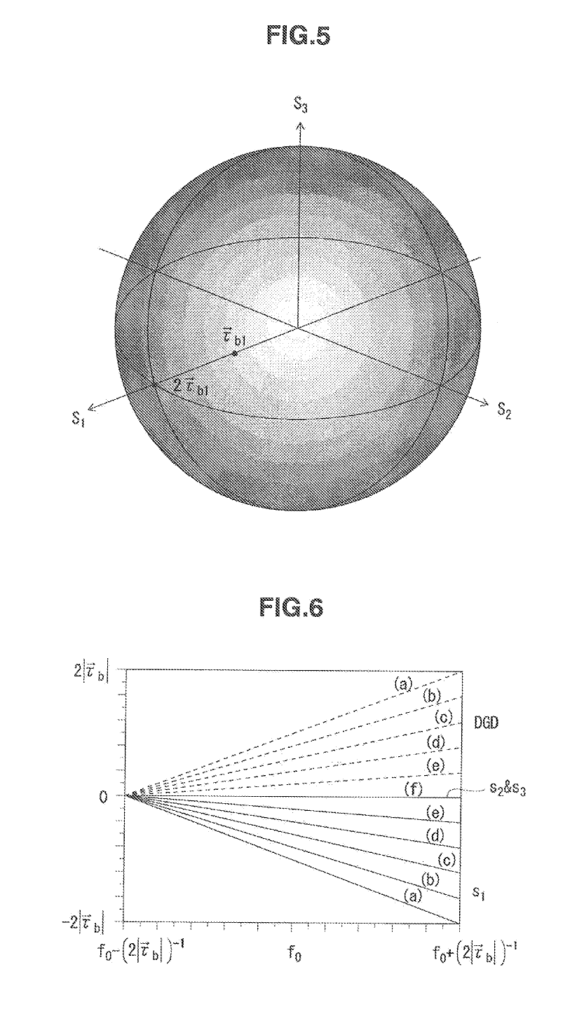

The relation between a Stokes parameter and the magnitude of the DGD when only the magnitude of the DGD is changed, so as to obtain Ω(ω)=(|Ω(ω)|,0,0)^{T} without giving the frequency rotation of a Principal State of Polarization (PSP) of the first and second birefringent crystals (104 and 106), will be described by referring to FIG. 6. Only a Polarization-dependent Chromatic Dispersion (PCD), which is the frequency dependence of DGD at this time, will be generated. The horizontal axis of FIG. 6 shows the frequency in a range of f₀−(2|τ_{b}|)⁻¹ to f₀+(2|τ_{b}|)⁻¹, and the vertical axis of FIG. 6 shows the magnitude of the Stokes parameters (s₁, s₂, s₃) in a range of −2|τ_{b}| to 2|τ_{b}|, and the magnitude of the DGD in a range of 0 to 2|τ_{b}|.

Changing only the magnitude of the DGD, so that a PMD vector becomes Ω(ω)=(|Ω(ω)|,0,0)^{T}, means that the s₁ component of the PMD vector is set to |Ω(ω)|, and the s₂ and s₃ components are set to 0. The s₁ component of the PMD vector is shown in FIG. 6 as a solid line, and the s₂ and s₃ components are shown as 0. Further, a dotted line shows the magnitude (DGD) of the PMD vector. (a) to (f) show a plurality of states in which the inclination of the PCD is different.

As shown in FIG. 6, it is possible to independently control only a PCD component that is one of the second-order PMD components. Further, the magnitude of the PMD component can be arbitrary set.

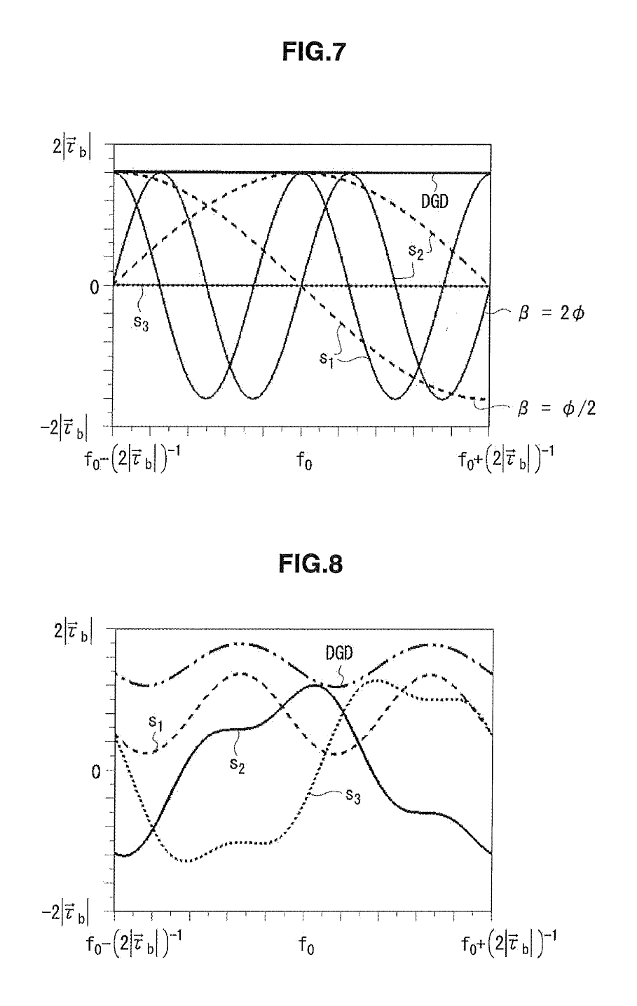

Next, rotating only the PSP with a DGD as a constant (PCD=0), which does not depend on the frequency, will be described by referring to FIG. 7. In this case, only a DR is generated. The horizontal axis of FIG. 7 shows the magnitude of the DGD converted into a frequency in a range of f₀−(2|τ_{b}|)⁻¹ to f₀+(2|τ_{b}|)⁻¹, and the vertical axis of FIG. 7 shows the magnitude of the Stokes parameters (s₁, s₂, s₃) in a range of −2|τ_{b}| to 2|τ_{b}|, and the magnitude of the DGD in a range of 0 to 2|τ_{b}|. The cases where a frequency transition of the PMD vector makes one round (shown as β=2φ) and ¼ round (shown as β=φ/2) by a FSR band, are shown in FIG. 7. As shown in FIG. 7, it can be seen that it is possible to generate a DR independently for the PCD by keeping the PCD constant.

### (Effect)

As described above, according to the PMD generating device of the present invention, it is possible to independently control a PMD, a PCD, and a DR over wide wavelength bands (by converting to a frequency, bands of f0−(2|τb|)−1 to f0+(2|τb|)−1), and it can be seen to be suitable by using an evaluation of an optical transmission system. Further, since it is possible to form only a connection between two birefringent crystals of an equal structure (the first birefringent crystal 104 and the second birefringent crystal 106), and two Stokes mapping devices of an equal structure (the first Stokes mapping device 105 and the second Stokes mapping device 107), it is a suitable configuration for mass production.

In addition, in all the operations including variable DGD operations necessary for PMD vector generation by the first Stokes mapping device 105 and the Second Stokes mapping device 107, since the phase in a range of 0 to 2π (range of SFR) may be adjusted and the phase difference for generation is small, the design of these Stokes mapping devices is easy. In a PMD generating model that uses the generation of an optical delay in the range of a pico second, while a response speed until arriving at the intended delay amount is a low speed, and is seen as unsuitable in an imitation of a similar PMD which is generated by a fiber side circuit, for rotating the SOP one round on the Stokes space for the delay amount of an optical transportation wave period, by using a phase shift in a range of 0 to 2π, a high speed device can be used, in which it is possible to have an imitation of a PMD such as that generated by a fiber side circuit, and has a response speed in the range of a micro second of an electro-optical effect.

A PMD, a PCD and a DR can be independently controlled by only controlling the first Stokes mapping device 105 and the Second Stokes mapping device 107, and it is possible to deterministically and arbitrary generate the PMD, PCD and DR by a simple algorithm using a trigonometric function.

### <Method of Generating PMD Vectors>

A method of generating intended PMD vectors according to the PMD generating device described above will be described. Here, a PMD vector given by the following Equation (5) is assumed to be an intended PMD vector. In Equation (5), the vectors (s₁(ω), s₂(ω), s₃(ω)) are standardized to a size of 1.

$$\text{?} \\ \text{?} \text{indicates text missing or illegible when filed} \qquad ( 5 )$$

A method of generating PMD vectors is realized by successively implementing the steps 1 to 4 shown below. (1) Step 1 (DGD mapping step)

Step 1 is a step where a DGD parameter, which determines the DGD for each frequency of the intended PMD, is set to the first Stokes mapping device 105. Specifically, a DGD parameter is set to the second polarization rotation device 111 of the first Stokes mapping device 105, such as the DGD parameter δ(ω) given by the following Equation (6):

$$δ ( ω ) = {cos}^{- 1} \{ \frac{1}{2} {( \frac{\vert \text{?} ( ω ) \vert}{\vert \text{?} \vert} )}^{2} - 1 \} \\ \text{?} \text{indicates text missing or illegible when filed} \qquad ( 6 )$$

(2) Step 2 (Birefringent Phase Cancelling Step)

Step 2 is a step where PMD vectors different for each frequency are collected in an S₁-S₂ plane of a Stokes space. Specifically, the SOP of light input to the first polarization rotation device 110 is adjusted, and the first polarization rotation device 110 is adjusted, so as to satisfy the relation, given by γ(ω)=−φ(ω), between the phase difference γ(ω) corresponding to the DGD, which gives the rotation amount of a rotation with an S₁ axis, which defines a Stokes space, as a center of rotation, and the phase difference φ(ω), which gives the rotation ratio around an inherent axis of the second birefringent crystal 106.

(3) Step 3 (PMD Spectrum Collecting Step)

Step 3 is a step where the PMD vectors distributed at positions different for each frequency in the S₁-S₂ plane of a Stokes space are collected in the S₁ axis of the Stokes space.

While a variable DGD is implemented by the synthesis of two PMD vectors, since the synthesized and generated PMD vectors are different in that the direction depends on the magnitude of the DGD, PMD vectors different for each frequency are collected at a point of a Stokes space by controlling the phase difference β(ω) corresponding to the DGD generated by the fourth polarization rotation device 113. The condition in which the PMD vectors are collected at a point of a Stokes space is set to β(ω)=−δ(ω)/2. That is, this step is a step where the phase difference β(ω) corresponding to the DGD generated by the fourth polarization rotation device 113 is set to −δ(ω)/2, and the PMD vectors, with a direction different for the magnitude of the DGD, are collected at a point of a Stokes space by operating the fourth polarization rotation device 113 and adjusting β(ω).

(4) Step 4 (Intended PMD Vector Defining Step)

Step 4 is a step where the phase difference α(ω) corresponding to the DGD generated by the third polarization rotation device 112, and the phase difference β(ω) corresponding to the DGD generated by the fourth polarization rotation device 113, are defined based on a Stokes component of an intended PMD vector.

Specifically, the phase difference α(ω) corresponding to the DGD generated by the third polarization rotation device 112, and the phase difference β(ω) corresponding to the DGD generated by the fourth polarization rotation device 113, are defined so as to satisfy the following Equations (7) and (8):

$$\begin{matrix} α ( ω ) = \{ \begin{matrix}{tan}^{- 1} ( \frac{\vert {s}_{3} ( ω ) \vert}{\vert {s}_{2} ( ω ) \vert} ) & ( {s}_{2} ( ω ) < 0 ) \\ {tan}^{- 1} ( \frac{\vert {s}_{3} ( ω ) \vert}{\vert {s}_{2} ( ω ) \vert} ) + π & ( {s}_{2} ( ω ) > 0 ) \\ π / 2 & \\ - π / 2 & \\ 0 & \end{matrix} \\ ( {s}_{2} ( ω ) = 0 , and {s}_{3} ( ω ) > 0 ) \\ ( {s}_{2} ( ω ) = 0 , and {s}_{3} ( ω ) < 0 ) \\ ( {s}_{2} ( ω ) = 0 , and {s}_{3} ( ω ) = 0 ) & ( 7 ) \\ β ( ω ) = {cos}^{- 1} ( \frac{\vert {s}_{1} ( ω ) \vert}{\vert \text{?} \vert} ) - \frac{δ ( ω )}{2} \\ \text{?} \text{indicates text missing or illegible when filed} & ( 8 )\end{matrix}$$

In the case where the magnitude of the intended PMD vector is 0 as a special condition (in the case where |Ω(ω)|=0), α(ω)=0, β(ω)=0, γ(ω)=0, and δ(ω)=π are defined. In Equations (7) and (8), the vectors (s₁(ω), s₂(ω), s₃(ω)) are standardized to a size of 1.

The possibility of generating an intended PMD vector, by implementing steps 1 to 4 described above, will be described by referring to FIGS. 8-12. In FIGS. 8-12, each horizontal axis shows the frequency in a range of f₀−(2|τ_{b}|)⁻¹ to f₀+(2|τ_{b}|)⁻¹, and each vertical axis shows the magnitude of the Stokes parameters (s₁, s₂, s₃) in a range of −2|τ_{b}| to 2|τ_{b}|, and the magnitude of the DGD in a range of 0 to 2|τ_{b}|. In any one of FIGS. 8-12, a curved line, which shows the Stokes parameters (s₁, s₂, s₃), and the DGD are shown by s₁, s₂, s₃ and DGD, respectively.

FIG. 8 is a figure which shows intended PMD vectors and the frequency dependence of DGD set by the above described Equation (5).

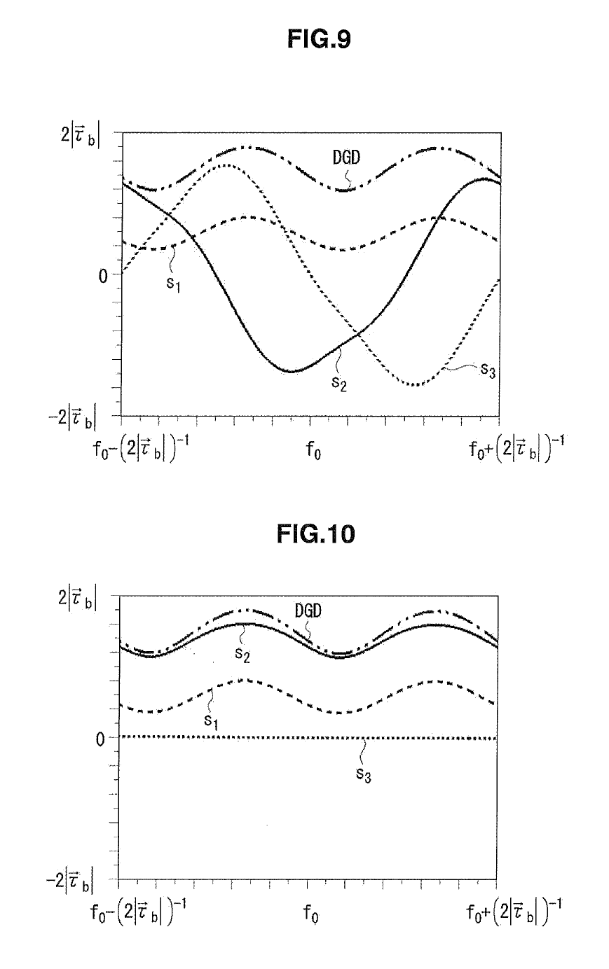

FIG. 9 is a figure which shows, in the operation of step 1 that is a step where DGD mapping is implemented, PMD vectors of the PMD generating device 103 and the frequency dependence of DGD, in the case where a DGD parameter δ(ω) is set to the first Stokes mapping device 105, such as that given by Equation (6) described above, and the setting value of α(ω), β(ω) and γ(ω) is 0 (not set).

FIG. 10 is a figure which shows, in the operation of step 2 that is a step cancelling a birefringent phase, PMD vectors of the PMD generating device 103 and the frequency dependence of DGD, in a state where the operation of step 1 has been added, and γ(ω) has been adjusted so as to satisfy the relation given by γ(ω)=−φ(ω). Here, α(ω) and β(ω) are 0.

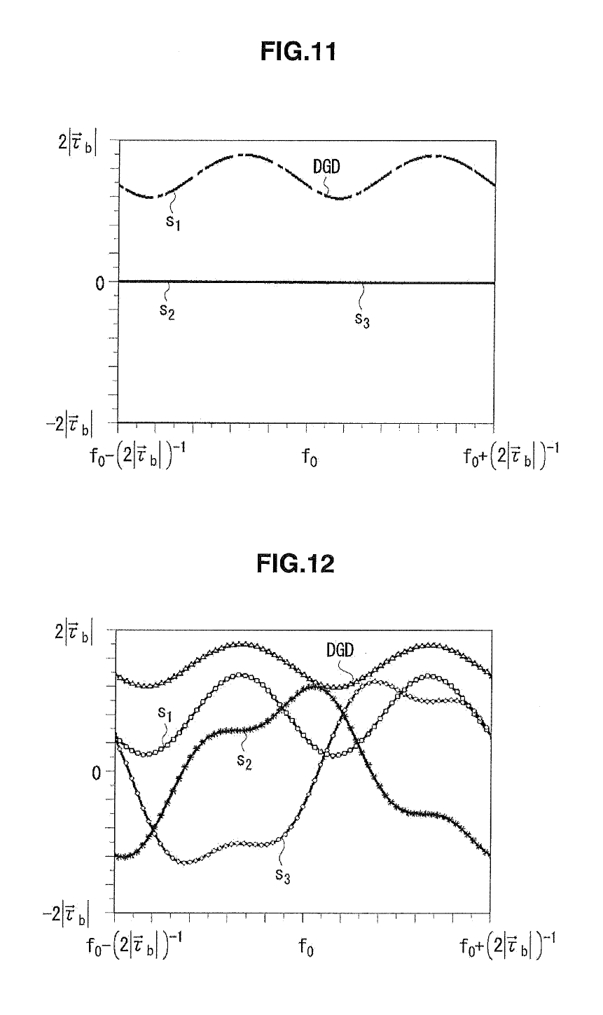

FIG. 11 is a figure which shows, in the operation of step 3 that is a step collecting a PMD spectrum, PMD vectors of the PMD generating device 103 and the frequency dependence of DGD, in a state where the operations of steps 1 and 2 have been added, and a condition, in which the PMD vectors are collected at a point of a Stokes space, is set to β(ω)=−δ(ω)/2. Here, α(ω) is 0.

FIG. 12 is a figure which shows, in the operation of step 4 that is a step defining an intended PMD vector, PMD vectors and the frequency dependence of DGD, in a state where the operations of steps 1 to 4 have been added, and α(ω)=β(ω) are defined so as to satisfy Equations (7) and (8) described above. This represents the PMD vectors shown in FIG. 8 and the frequency dependence of similar DGD. That is, it means that it is possible to generate an intended PMD vector by implementing the steps 1 to 4.

As described above, it is possible to arbitrary generate PMD vectors, which are different depending on the frequency, within a sphere with a radius of 2|τ_{b}| in a Stokes space. Since the purpose of the phase difference γ(ω) is to cancel a birefringent phase of the second birefringent crystal 106, it may be a fixed number set once. Further, it may not be necessary for the phase difference α(ω), the phase difference β(ω) and the phase difference δ(ω) to be complex algorithms for deterministically requesting by only a trigonometric function by the intended PMD vector, such as described above. Further, since it is possible for an intended PMD vector, which has this PMD spectrum by implementing the steps 1 to 4, to be generated, a PMD vector, which equalizes this PMD spectrum, can be calculated when the PMD spectrum generated by an optical transmission path is already known, and it is possible to generate a PMD vector which equalizes the PMD spectrum generated by the optical transmission route.

### <PMD Compensating Device>

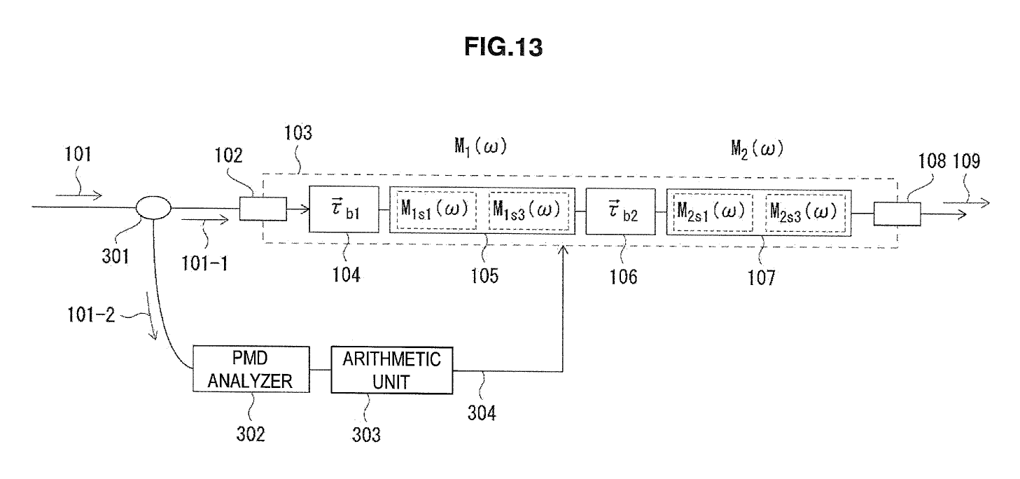

A configuration of a PMD compensating device according to the embodiments of the present invention, the operation thereof, and the obtained effects, will be described by referring to FIG. 13.

### (Configuration)

FIG. 13 is a schematic block diagram of a PMD compensating device. The PMD compensating device includes an optical divider 301, a PMD generating device 103, a PMD analyzer 302, and an arithmetic unit 303. The optical divider 301 divides input signal light 101 into first input signal light 101-1 and second input signal light 101-2. The PMD generating device 103 uses the PMD generating device described above.

The PMD analyzer 302 measures PMD vectors of the second input signal light 101-2. A commercial device can be arbitrary used for the PMD analyzer.

The arithmetic unit 303 requests inverse PMD vectors based on the PMD vectors obtained by the PMD analyzer 302, and calculates control parameters for controlling the PMD generating device 103. α(ω), β(ω) and γ(ω) calculated by the arithmetic unit 303 are input to the PMD generating device 103 as control signals 304. Then, based on these control signals 304, α(ω), β(ω) and γ(ω) are set in the first polarization rotation device 110, the second polarization rotation device 111, the third polarization rotation device 112, and the fourth polarization rotation device 113, which configure the PMD generating device 103.

Note that it is suitable for a polarization plane controller (omitted from the figure), which arbitrary adjusts the SOP of the input signal light 101-1 entering a crystal axis of the first birefringent crystal 104, to be further arranged before the first birefringent crystal 104. That is, it is preferable have a configuration in which the input signal light 101-1 is input to this polarization plane controller, and the output light output from this polarization plane controller is input to the PMD generating device 103.

### (Operation)

In the case where the PMD vectors generated by the optical transmission path are given by the following Equation (9), if the inverse PMD vectors given by the following Equation (10), in the compensation of these PMD vectors, are generated by the PMD generating device 103, The PMD vectors generated by the optical transmission path can be equalized.

$$\begin{matrix} \text{?} ( ω ) = \vert \text{?} ( ω ) \vert ( \begin{matrix}{s}_{1} ( ω ) \\ {s}_{2} ( ω ) \\ {s}_{3} ( ω )\end{matrix} ) & ( 9 ) \\ \text{?} ( ω ) = - \vert \text{?} ( ω ) \vert ( \begin{matrix}{s}_{1} ( ω ) \\ {s}_{2} ( ω ) \\ {s}_{3} ( ω )\end{matrix} ) \\ \text{?} \text{indicates text missing or illegible when filed} & ( 10 )\end{matrix}$$

The PMD spectrum generated by the optical transmission path is measured by the PMD analyzer 302, and based on this measuring result, sets the inverse PMD vectors to the intended PMD vectors by the arithmetic unit 303, and δ(ω), α(ω) and β(ω), which satisfy Equations (6), (7) and (8), are calculated. Here, γ(ω) is a parameter of a fixed number, which cancels the birefringent phase of the second birefringent crystal 106, and may be set to γ(ω)=−φ(ω).

### (Effect)

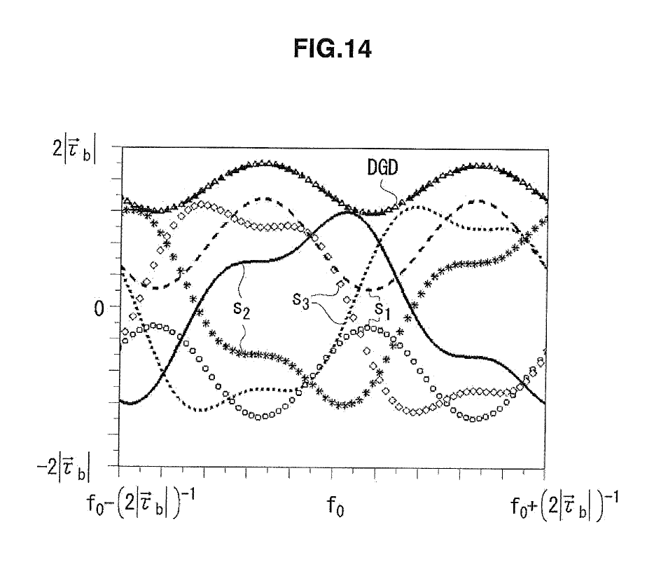

The inverse PMD vectors generated by the PMD generating device 103 will be described in FIG. 14. The horizontal axis of FIG. 14 shows the frequency in a range of f₀−(2|τ_{b}|)⁻¹ to f₀+(2|τ_{b}|)⁻¹, and the vertical axis of FIG. 14 shows the magnitude of the Stokes parameters (s₁, s₂, s₃) in a range of −2|τ_{b}| to 2|τT_{b}|, and the magnitude of the DGD in a range of 0 to 2|τ_{b}|. In FIG. 14, the Stokes parameters (s₁, s₂, s₃) shown by dotted lines correspond to the PMD vectors generated by the optical transmission path, and the Stokes parameters (s₁, s₂, s₃) shown by white circles, rectangles and stars correspond to the inverse PMD vectors generated by the PMD generating device 103.

If the Stokes parameters (s₁, s₂, s₃) shown by white circles, rectangles and stars are subtracted from the Stokes parameters (sᵢ, s₂, s₃) shown by dotted lines, it is perceived that each of the Stokes parameters (s₁, s₂, s₃) will become a constant value for the frequency of the input signal light. That is, it can be seen that the inverse PMD vectors are generated by the PMD generating device 103 for the PMD vectors generated by the optical transmission path, and it is shown that the PMD vectors generated by the optical transmission line can be compensated by the inverse PMD vectors generated by the PMD generating device 103.

### <Another Embodiment of the PMD Generating Device>

In the PMD generating device described above, while the birefringent crystals are used as the first birefringent crystal 104 and the birefringent crystal 106, they can be used if they are elements which generate PMD vectors without wavelength dependency. For example, it is possible to use a polarization surface maintaining optical fiber or an optical path length variable type PMD medium. When the first Stokes mapping device 105 and the second Stokes mapping device 107 are configured, while elements, which rotate a polarization surface with an S₁ axis or S₃ axis as a center of rotation, are selected as polarization rotation elements having an orthogonal polarization rotation axis, it is possible to replace these elements, which rotate a polarization surface with an S₁ axis and S₃ axis as a center of rotation, when they are elements in which Stokes mapping is arbitrary implemented.

Here, while PMD vectors different for each frequency are collected in the S₁ axis, which defines a Stokes space, it is not limited to the S₁ axis, and they may be collected in the S₂ axis or the S₃ axis, which arbitrary define a Stokes space.

What is claimed is:

1. A polarization mode dispersion generating device, comprising:
a first birefringent crystal, a first Stokes mapping device, a second birefringent crystal and a second Stokes mapping device;
wherein the first birefringent crystal adds a first polarization mode dispersion, when input signal light is input;
wherein the first Stokes mapping device variably controls a state of polarization for each wavelength, when output light output from the first birefringent crystal is input;
wherein the second birefringent crystal adds a second polarization mode dispersion, when output light output from the first Stokes mapping device is input; and
wherein the second Stokes mapping device variably controls the state of polarization for each wavelength, when output light output from the second birefringent crystal is input.

2. The polarization mode dispersion generating device according to claim 1,
wherein the first Stokes mapping device comprises a first polarization rotation device and a second polarization rotation device, and the second Stokes mapping device comprises a third polarization rotation device and a fourth polarization rotation device;
wherein each of the first polarization rotation device and the third polarization rotation device continuously and variably adjusts a rotation amount with an S₁ axis, which defines a Stokes space, as a center of rotation; and
wherein each of the second polarization rotation device and the fourth polarization rotation device continuously and variably adjust a rotation amount with an S₃ axis, which defines a Stokes space, as a center of rotation.

3. The polarization mode dispersion generating device according to claim 2,
wherein the first polarization rotation device comprises a polarization beam splitter, a first ¼ wavelength plate, a second ¼ wavelength plate, a first reflecting mirror and a minute dispersion generating device;
wherein output light output from the first birefringent crystal is input to the polarization beam splitter, and is separated into two orthogonal polarization components;
wherein one polarization component of the two polarization components passes through the first ¼ wavelength plate, is reflected by the first reflecting minor, passes again through the first ¼ wavelength plate, is reflected by the polarization beam splitter, and is input to the second polarization rotation device; and
wherein the other polarization component passes through the second ¼ wavelength plate, is input to the minute dispersion generating device, is output after a phase shift amount for each wavelength of this other polarization component is adjusted, and the output light passes again though the second ¼ wavelength plate, passes through the polarization beam splitter, and is input to the second polarization rotation device.

4. The polarization mode dispersion generating device according to claim 2,
wherein the third polarization rotation device comprises a polarization beam splitter, a first ¼ wavelength plate, a second ¼ wavelength plate, a first reflecting mirror and a minute dispersion generating device;
wherein output light output from the second birefringent crystal is input to the polarization beam splitter, and is separated into two orthogonal polarization components;
wherein one polarization component of the two polarization components passes through the first ¼ wavelength plate, is reflected by the first reflecting minor, passes again through the first ¼ wavelength plate, is reflected by the polarization beam splitter, and is input to the fourth polarization rotation device; and
wherein the other polarization component passes through the second ¼ wavelength plate, is input to the minute dispersion generating device, is output after a phase-shift amount for each wavelength of this other polarization component is adjusted, and the output light passes again though the second ¼ wavelength plate, passes through the polarization beam splitter, and is input to the fourth polarization rotation device.

5. The polarization mode dispersion generating device according to claim 2,
wherein the second polarization rotation device comprises a third ¼ wavelength plate, a polarization beam splitter, a first ¼ wavelength plate, a second ¼ wavelength plate, a first reflecting mirror, a minute dispersion generating device, and a fourth ¼ wavelength plate;
wherein output light that has been output from the first polarization rotation device and has passed through the third ¼ wavelength plate is input to the polarization beam splitter, and is separated into two orthogonal polarization components;
wherein one polarization component of the two polarization components passes through the first ¼ wavelength plate, is reflected by the first reflecting minor, passes again through the first ¼ wavelength plate, is reflected by the polarization beam splitter, passes through the fourth ¼ wavelength plate, and is input to the second birefringent crystal; and
wherein the other polarization component passes through the second ¼ wavelength plate, is input to the minute dispersion generating device, is output after a phase shift amount for each wavelength of this other polarization component is adjusted, and the output light passes again though the second ¼ wavelength plate, passes through the polarization beam splitter, passes through the fourth ¼ wavelength plate, and is input to the second birefringent crystal.

6. The polarization mode dispersion generating device according to claim 2,
wherein the fourth polarization rotation device comprises a third ¼ wavelength plate, a polarization beam splitter, a first ¼ wavelength plate, a second ¼ wavelength plate, a first reflecting mirror, a minute dispersion generating device, and a fourth ¼ wavelength plate;
wherein output light that has been output from the third polarization rotation device and has passed through the third ¼ wavelength plate is input to the polarization beam splitter, and is separated into two orthogonal polarization components;
wherein one polarization component of the two polarization components passes through the first ¼ wavelength plate, is reflected by the first reflecting minor, passes again through the first ¼ wavelength plate, is reflected by the polarization beam splitter, passes through the fourth ¼ wavelength plate, and is output to the outside; and
wherein the other polarization component passes through the second ¼ wavelength plate, is input to the minute dispersion generating device, is output after a phase shift amount for each wavelength of this other polarization component is adjusted, and the output light passes again though the second ¼ wavelength plate, passes through the polarization beam splitter, passes through the fourth ¼ wavelength plate, and is output to the outside.

7. The polarization mode dispersion generating device according to claim 3,
wherein the minute dispersion generating device comprises a collimator mirror, a diffraction grating, a lens, a phase shifter array, and a second reflecting mirror; and
wherein the polarization component which is the other polarization component of the two orthogonal polarization components, and which has passed through the second ¼ wavelength plate, successively passes through the collimator mirror, the diffraction grating, the lens, and the phase shifter array, is reflected by the second reflecting mirror, passes again through the phase shifter array, the lens and the diffraction grating in this order, is reflected by the collimator minor, and returns to the second ¼ wavelength plate.

8. A method for generating polarization mode dispersion which generates an intended polarization mode dispersion using the polarization mode dispersion generating device according to claim 1, comprising:
a first step of setting polarization state parameters, which determine the state of polarization for each frequency, to a first Stokes mapping device;
a second step of collecting polarization mode dispersion vectors, which are different for each frequency of the intended polarization mode dispersion, in an S₁-S₂ plane of a Stokes space;
a third step of collecting polarization mode dispersion vectors, which are distributed at positions different for each frequency in the S₁-S₂ plane of the Stokes space, in an S₁ axis of the Stokes space; and
a fourth step of defining a phase difference corresponding to the state of polarization generated by the third polarization rotation device, and a phase difference corresponding to the state of polarization generated by the fourth polarization rotation device, based on a Stokes component of the intended polarization mode dispersion vectors.

9. A polarization mode dispersion compensating device, comprising:
an optical divider which divides input signal light into first input signal light and second input signal light;
the polarization mode dispersion generating device according to claim 1;
a polarization mode dispersion analyzer which measures polarization mode dispersion vectors of the second input signal light; and
an arithmetic unit which requests inverse polarization mode dispersion vectors based on the polarization mode dispersion vectors obtained by the polarization mode dispersion analyzer, and calculates control parameters for controlling the polarization mode dispersion generating device;
wherein the first input signal light is input to the polarization mode dispersion generating device, and the second input signal light is input to the polarization mode dispersion analyzer.

10. The polarization mode dispersion compensating device according to claim 9,
wherein a polarization plane controller, which arbitrary adjusts the state of polarization of the input signal light entering a crystal axis of the first birefringent crystal, is further arranged before the first birefringent crystal of the polarization mode dispersion generating device; and
wherein the first input signal light is input to the polarization plane controller, and the output light output from the polarization plane controller is input to the polarization mode dispersion generating device.
